(19) United States
(12) Patent Application Publication
(10) Pub. No.: US 2016/0215979 A1
(43) Pub. Date: Jul. 28, 2016

(54) REFRACTORY BRICKS AND METHODS OF IDENTIFYING A REFRACTORY BRICK COMPOSITION

(71) Applicant: Resco Products, Inc., Pittsburgh, PA (US)

(72) Inventor: Richard C. Kaldon, Upper St. Clair, PA (US)

(21) Appl. No.: 14/604,350

(22) Filed: Jan. 23, 2015

(51) Int. Cl. F23M 5/02; F27D 1/04; F27D 1/10; F27D 1/00

(52) U.S. Cl. CPC F23M 5/02; F27D 1/004; F27D 1/04; F27D 1/10

(57) ABSTRACT

A refractory brick including comprises a first face configured to be disposed toward a heating zone of a high-temperature vessel, a second face opposite the first face, a side face extending between the first face and the second face, and an indicia on at least one of the second face and the side face. The indicia corresponds to a composition of the refractory brick. The indicia allows one to identify the composition of the refractory brick, for example, after the brick has been in service in a lining of a high-temperature vessel or other furnace.

### BACKGROUND OF THE TECHNOLOGY

1. Field of Technology

The present disclosure relates to refractory bricks and methods of identifying a composition of the same. In particular, certain non-limiting aspects of the present disclosure relate to a refractory brick including an indicia corresponding to a composition of the refractory brick. More specifically, the refractory brick includes a first face configured to be disposed toward a heating zone of a high-temperature vessel, and a second face opposite the first face, and the second face includes indicia that may be used to identify a composition of the refractory brick.

2. Description of the Background of the Technology

A high-temperature vessel is a thermally insulated chamber, a furnace, that produces temperatures in the chamber sufficient to complete some process, such as hardening, drying, refining, or chemical changes. Material to be heated within the vessel is disposed in the chamber for a period of time sufficient to complete the process. The vessel shell is normally made from mild steel. Mild steel can have temperature limitations to maintain suitable strength and, therefore, the interior surface of a vessel is lined with individual refractory elements, known in the industry as refractory “bricks,” to insulate the vessel shell from the high temperatures within the vessel's interior.

In the production of refractory bricks, some quantity of recycled or reclaimed raw material may be utilized to reduce cost. Recycled materials may be obtained from spillage that occurs during pressing the refractory bricks, and from unfired or fired bricks in whole or in part. For example, portions of bricks that are cracked, broken, or have unacceptable appearance during production may be utilized as recycled materials. Reclaimed materials may be obtained from unused bricks that have become obsolete or are otherwise not placed into service. The raw materials derived by crushing and grinding pre-formed unfired or fired refractory bricks are commonly referred to as “batts.”

In some cases, refractory bricks that have been used in high-temperature vessel linings in high temperature processes can be economically retrieved, sorted, and cleaned as needed to eliminate contamination for use in “batt” form. For example, among the wide variety of refractory brick compositions used in high temperature industrial processes, those that contain carbon in the form of graphite or other carbonaceous materials typically may be readily reclaimed after service to produce batts. The non-wetting and non-reactive nature of carbon can minimize penetration of the furnace charge into carbon-containing bricks. Therefore, refractory brick compositions that contain carbon may remain non-contaminated even after being exposed to process conditions within the vessel including liquid steel and slag. When considered too thin to remain in service, a high-temperature vessel lining including carbon-containing refractory bricks may be cleaned and reclaimed for use in batts, as a partial substitute for virgin raw material.

Current refractory lining practice in ladle refining furnaces in the steel industry utilizes one type of refractory bricks for the upper portion of the sidewall lining, which is in contact with corrosive slag for relatively long time periods, and another type of refractory bricks having a differing composition in the balance of the sidewall and the bottom of the lining. For example, the refractory bricks in the upper portion of the refining furnace sidewall lining may be magnesia carbon bricks, while the refractory bricks in the balance of the sidewall and the bottom of the lining may be alumina-magnesia-carbon (AMG) bricks. The carbon-containing bricks in the lower portion of the sidewall and in the bottom of the lining can be reused as recycled/reclaimed material, i.e., batts, in the production of new refractory bricks. To ensure proper reuse, it is important to separate the magnesia carbon bricks from the AMG bricks during retrieval.

### SUMMARY

One non-limiting aspect of the present disclosure is directed to a refractory brick including a first face configured to be disposed toward a heating zone of a high-temperature vessel, a second face opposite the first face, a side face extending between the first face and the second face. An indicia corresponding to a composition of the refractory brick is on at least one of the second face and the side face. The indicia allows one to identify the composition of the refractory brick, for example, after the brick has been in service in a lining of a high-temperature vessel.

Another non-limiting aspect of the present disclosure is directed to a set of refractory bricks comprising a first refractory brick and a second refractory brick. The first refractory brick includes a first face configured to be disposed toward a heating zone of a high-temperature vessel, a second face opposite the first face, and a side face extending between the first face and the second face of the first refractory brick. The second refractory brick includes a primary face configured to be disposed toward the heating zone of the high-temperature vessel, a secondary face opposite the primary face, a second side face extending between the primary face and the secondary face, and an indicia on at least one of the secondary face and the second side face. The indicia corresponds to a composition of the second refractory brick. The indicia allows one to identify the composition of the second refractory brick, for example, after the brick has been in service in a lining of a high-temperature vessel.

Another non-limiting aspect of the present disclosure is directed to a method of identifying a composition of at least a subset of a plurality of refractory bricks that have been in service in the lining of a high-temperature vessel. Such brick may be referred to as “spent” refractory bricks. The method comprises providing a plurality of spent refractory bricks, wherein each of at least a subset of the plurality of spent refractory bricks includes a first face that has been exposed to a heating zone of a high-temperature vessel, a second face opposite the first face, and a side face extending between the first face and the second face, and wherein an indicia corresponding to a composition of the refractory brick is on at least one of the second face and the side face of the subset of spent bricks. Refractory bricks in the subset comprising the same composition include the same indicia. The method further comprises identifying a composition of spent refractory bricks within the subset of spent refractory bricks using the indicia.

### BRIEF DESCRIPTION OF THE DRAWINGS

Features and advantages of the compositions, methods, and articles described herein may be better understood by reference to the accompanying drawings in which:

FIG. 1 is a perspective cut-away view of a high-temperature vessel including a lining comprising non-limiting embodiments of refractory bricks according to the present disclosure.

FIG. 2 is a perspective view of a non-limiting embodiment of a refractory brick according to the present disclosure.

FIG. 3 is a perspective view of another non-limiting embodiment of a refractory brick according to the present disclosure.

FIG. 4 is a perspective view of another non-limiting embodiment of a refractory brick according to the present disclosure.

FIG. 5 is a flow chart of a non-limiting embodiment of a method of identifying a composition of at least a subset of a plurality of spent refractory bricks according to the present disclosure.

The reader will appreciate the foregoing details, as well as others, upon considering the following detailed description of certain non-limiting embodiments of articles and methods according to the present disclosure. The reader also may comprehend certain of such additional details upon using the articles and methods described herein.

### DETAILED DESCRIPTION OF CERTAIN NON-LIMITING EMBODIMENTS

In the present description of non-limiting embodiments and in the claims, other than in the operating examples or where otherwise indicated, all numbers expressing quantities or characteristics of ingredients and products, processing conditions, and the like are to be understood as being modified in all instances by the term “about.” Accordingly, unless indicated to the contrary, any numerical parameters set forth in the following description and the attached claims are approximations that may vary depending upon the desired properties one seeks to obtain in the methods and articles according to the present disclosure. At the very least, and not as an attempt to limit the application of the doctrine of equivalents to the scope of the claims, each numerical parameter should at least be construed in light of the number of reported significant digits and by applying ordinary rounding techniques.

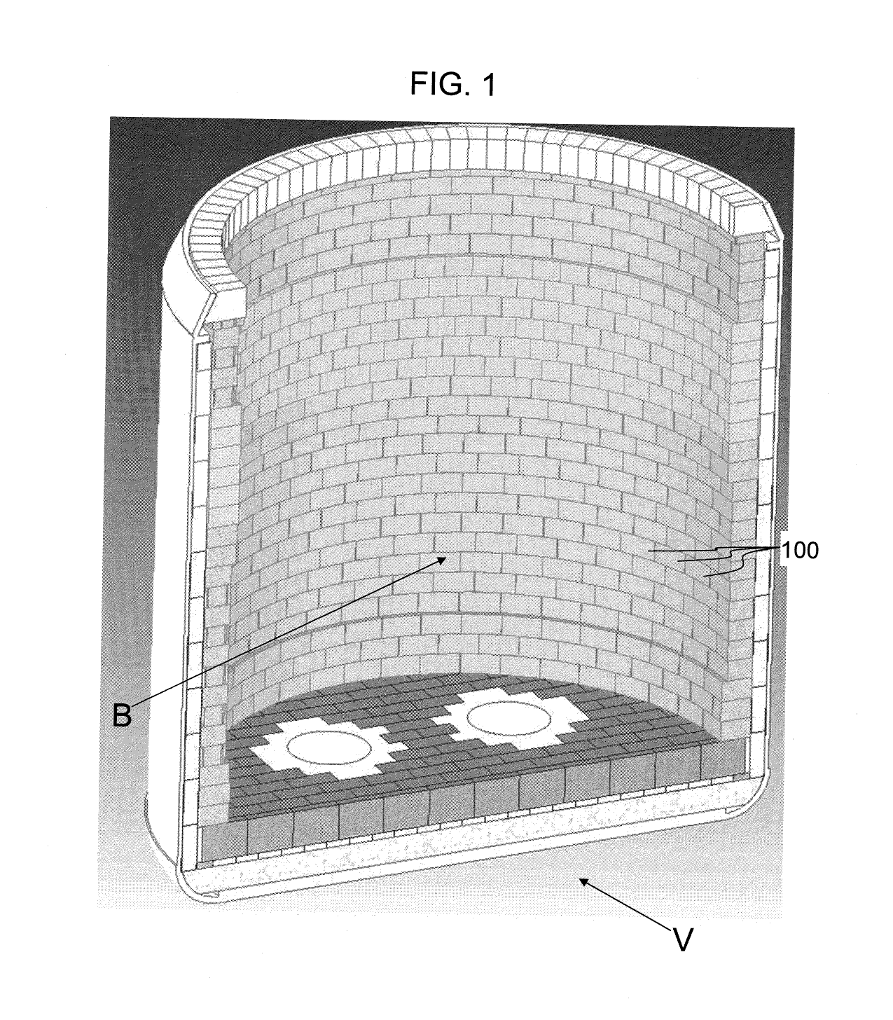

The present disclosure, in part, is directed to a refractory brick including an indicia corresponding to a composition of the refractory brick. The indicia may be used to identify the composition of the refractory brick after the brick has been in service in a lining of a high-temperature vessel. Referring to FIGS. 1-3, non-limiting embodiments of a plurality of refractory bricks according to the present disclosure are illustrated. FIG. 1 shows a plurality of the refractory bricks 100 according the present disclosure assembled in the thermally insulating lining of a high-temperature vessel “V.” High-temperature vessels include, for example, rotary kilns and stationary kilns, which may be referred to simply as “furnaces,” ladles, and ladle refining furnaces. It is to be understood that the term “high-temperature vessel” as used herein is intended in a generic sense and is not limited to any specific configuration so long as it can produce temperatures in a chamber sufficient to complete some process, such as hardening, drying, refining, or chemical changes.

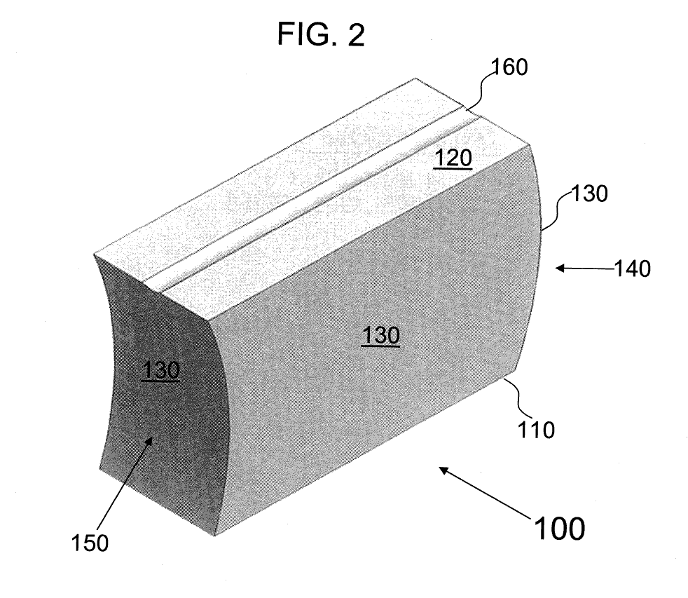

With reference to FIG. 2, each refractory brick 100 includes a first or primary face 110 (not visible in the figure) configured to be disposed toward a heating zone “B” of the high-temperature vessel V, and a second or secondary face 120 opposite the first face 110. The first/primary face 110 configured to be disposed toward the heating zone B is typically referred to as a “hot” face, and the second/secondary face 120 opposite the first/primary face 110 is typically referred to as a “cold face”, the names corresponding to the relative temperatures to which the faces are exposed. In certain non-limiting embodiments, the refractory brick 100 can be configured so that the first (hot) face 110 and the second (cold) face 120 are curved identically. In other non-limiting embodiments, the first (hot) face 110 of a brick 100 may be shaped or otherwise configured in a way different from the brick's second (cold) face 120. Those having ordinary skill will readily understand that refractory bricks may be shaped/configured and sized so that the plurality of bricks forming the thermally insulating lining suitable fit the contour of the interior of a particular high-temperature vessel.

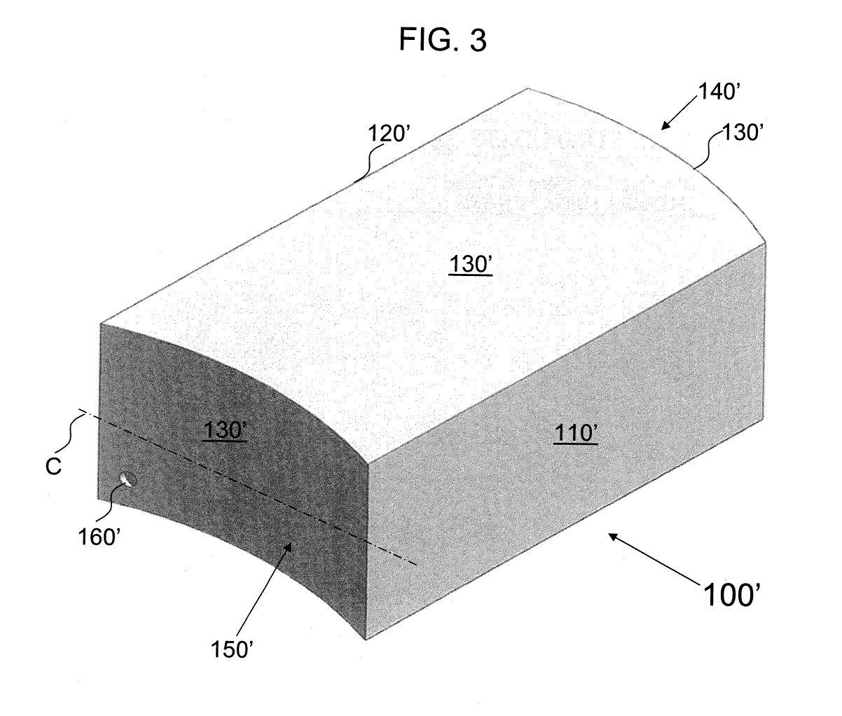

According to certain non-limiting embodiments, at least one side face 130 extends between the first face 110 and the second face 120 of the refractory brick 100. FIGS. 2-3 illustrate refractory bricks including six faces, where two opposing faces are the first and second faces, and the remaining four faces connecting the first face and the second face are the side faces. In various non-limiting embodiments, however, any other number of side faces may extend between the first face and the second face of a refractory brick according to the present disclosure.

A refractory “brick” is a term of art and will be readily understood by those having ordinary skill in the production of refractory compositions. The specific shape of the refractory brick may vary depending upon the size and other design criteria of the particular high-temperature vessel in which it is utilized. Typically, a refractory brick for use in a high-temperature vessel is shaped for being assembled in stacked relationship around the interior of the high-temperature vessel, and in certain configurations may include a side face 130 that is slightly curved or tapered between the first face 110 and the second face 120. It is to be understood, however, that the term “brick” as used herein is intended in a generic sense and is not limited to any specific configuration or shape so long as it can serve as an inner lining of a high-temperature vessel.

In the illustrated non-limiting embodiment of refractory brick 100 shown in FIG. 2, the side face 130 includes a convex or “male” portion or end 140 and a concave or “female” portion or end 150. The male and female portions 140, 150 of the refractory brick 100 can be fitted into one another to form rings of bricks around the interior of the high-temperature vessel V (see FIG. 1). According to certain non-limiting embodiments, the refractory brick 100 may be formed in a cavity of a brick press with the female portion 150 upward. In further non-limiting embodiments, the refractory brick 100 may be formed in a cavity of a brick press with a flat side face 130 upward. In other non-limiting embodiments, the refractory brick 100 may be formed by any other suitable method known in the art of forming refractory bricks, including casting.

According to certain non-limiting embodiments, the refractory brick 100 includes at least one indicia 160 corresponding to a composition of the refractory brick 100. In other words, the particular indicia 160 disposed on the brick may code for a particular composition.

Refractory bricks having different compositions can be used in the lining of a high-temperature vessel. The particular composition used in a particular region of the lining can differ from bricks in other regions of the lining depending on the design criteria or preferred operating parameters of the particular high-temperature vessel. According to certain non-limiting embodiments, the material for one particular region of the lining can differ from material for bricks in other regions of the lining and are selected from alumina-magnesia-carbon (AMG), magnesia-carbon, alumina-carbon, magnesia-alumina-carbon, and alumina-carbon-silicon carbide. For example, one region of a lining may include refractory bricks comprising AMG, and another region of the lining may include refractory bricks comprising magnesia carbon.

Because, for example, spent AMG bricks and spent magnesia carbon bricks can have similar shape, texture, size, and dark gray or black color, it can be difficult or cumbersome to distinguish one brick type from the other in a timely and reliable manner when identifying bricks for recycling. To aid in sorting spent refractory bricks, portable chemical analyzing equipment, such as an xSORT analyzer, manufactured by SPECTRO Analytical Instruments GmbH in Kleve, Germany, has been used. However, portable chemical analyzing equipment can be expensive, and using the equipment to sort brick types can be time-consuming and inefficient. For example, an area of the surface of the brick must be cleaned, the analyzer is aimed at the cleaned surface and activated, and results are read from a monitor screen. This operation can take 30 seconds or more per brick. In contrast, one can quickly and reliably identify the composition of a particular refractory brick, and differentiate between brick types, using the indicia 160 of brick 100. For example, using indicia 160, bricks having a particular indicia and corresponding composition typically can be visually identified in a reliable manner in no more than a few seconds per brick, and without the need for costly analytical equipment.

Referring to FIG. 2, the illustrated non-limiting embodiment of refractory brick 100 includes indicia 160, in the form of a linear groove that may be pressed into the brick when it is formed, positioned on the second face 120 of the refractory brick 100. In this way, the indicia 160 is protected from the environment within the heating zone B of the high-temperature vessel V, which can erode the indicia or otherwise render it non-visible after a period of exposure. As such, the indicia 160 is disposed on a surface of the brick 100 other than the first face 110, which is exposed to the heating zone B of the high-temperature vessel V.

FIG. 3 illustrates another non-limiting embodiment of a refractory brick according to the present disclosure. Refractory brick 100′ includes first or primary face 110′ configured to be disposed toward the heating zone of a high-temperature vessel, a second or secondary face 120′ opposite the first face 110′, and a side face 130′ connecting the first face 110′ and the second face 120′. Indicia 160′, in the form of hemispherical indentation or “dimple,” is disposed on the side face 130′.

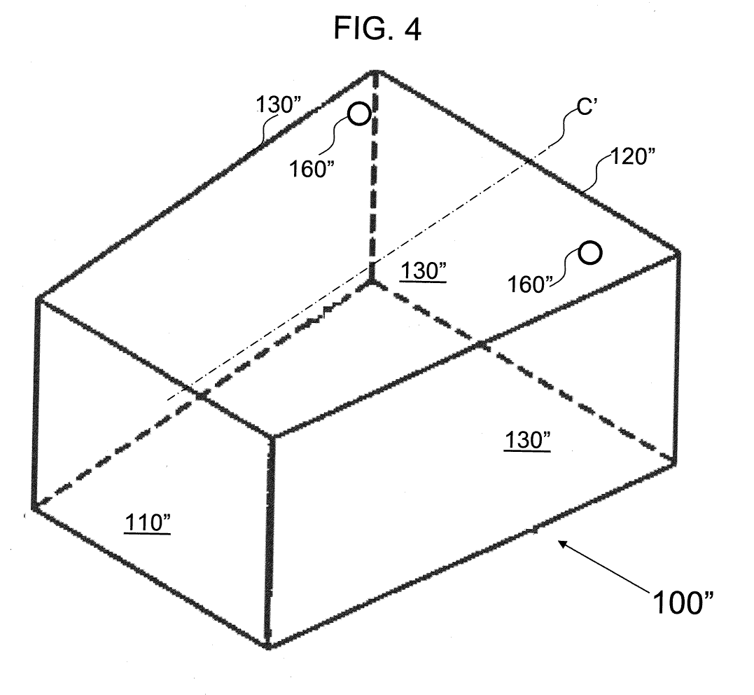

FIG. 4 illustrates another non-limiting embodiment of a refractory brick according to the present disclosure. Refractory brick 100″ includes first or primary face 110″ configured to be disposed toward the heating zone of a high-temperature vessel, a second or secondary face 120″ opposite the first face 110″, and a side face 130″ connecting the first face 110″ and the second face 120″. Indicia 160″, in the form of hemispherical indentation or “dimple,” are disposed on the side face 130″.

Although FIGS. 2-3 illustrate a single indicia on either the second face or a particular side face, in various non-limiting embodiments, one or more indicia may be included on the second face and/or any of the side faces of a refractory brick according to the present disclosure, as illustrated in FIG. 4. As discussed, if the identifying indicia were included on first face 110, 110′, 110″, i.e., which is a brick face exposed to the heating zone of the high-temperature vessel, the indicia may wear away or otherwise become non-visible during a period of service in the high-temperature vessel. Therefore, depending on the usage requirements or preference for the particular refractory bricks in the high-temperature vessel, placing the indicia on the first face 110, 110′, 110″ may not be suitable for identifying a composition of spent refractory bricks.

According to certain non-limiting embodiments of a refractory brick according to the present disclosure, such as the embodiments shown in FIGS. 2-4, the indicia comprises a groove or indentation. In certain other non-limiting embodiments, the indicia may be one or more of a notch, a groove, a dimple, and a raised shape. A groove such as, for example, indicia 160 in FIG. 2, may be formed by affixing a protrusion to, or otherwise providing a protrusion on, a surface of the mold cavity within which the refractory brick 100 is pressed, or on a plunger that is lowered into the cavity to pressure-form the refractory brick 100. The protrusion may extend at least partially along the mold component surface that forms the face on which the indicia is to be disposed and may have, for example, a semi-circular cross-section with a relatively small radius. Furthermore, a dimple such as, for example, indicia 160′ in FIG. 3 and indicia 160″ in FIG. 4, may be formed by providing a corresponding protrusion on a surface of the mold cavity within which the refractory brick 100′, 100″ is pressed, or on a plunger that is lowered into the cavity to pressure-form the refractory brick 100′, 100″.

Although examples of possible methods for forming the groove and dimple are given in the present disclosure, these examples do not encompass all possible options for forming the indicia according to the present disclosure. Rather, the present inventors determined that certain methods represent possible options that can produce indicia 160, 160′, and 160″ in the specific non-limiting embodiments illustrated in FIGS. 2-4. It is to be understood that the articles and methods of the present disclosure, including the indicia, can be formed by other suitable methods, which will be apparent to those having ordinary skill upon considering the present disclosure.

According to certain non-limiting embodiments, the indicia comprises a color, for example applied by high-temperature paint, crayons, or markers. In still other non-limiting embodiments, the indicia can include a number (e.g., “1” or “234”), a letter or letters (e.g., “A” or “BCD”), a symbol or symbols (e.g., “θ” or “▴”), or a combination of two or more of these (e.g., “A1”, “BC23”, or “1B▴2”). The indicia can assume any of a virtually unlimited variety of numbers, letters, alphanumerics, colors, shapes, designs, or combinations of any of these, for example, so long as the indicia is on at least one of the second face and the side face of the refractory brick and can be used as an indicator of (i.e., to identify) the composition of the refractory brick after the brick has been in service in a high-temperature vessel. Upon considering the present description, those having ordinary skill may readily design or identify other possible indicia that can be used to identify a composition of a spent refractory brick according to the present disclosure.

Referring to FIG. 3, in the illustrated non-limiting embodiment, the indicia 160′ is on the side face 130′ of the refractory brick 100′ at least two-thirds of the distance from the first face 110′ to the second face 120′. Similarly, in the non-limiting embodiment illustrated in FIG. 4, the indicia 160″ are on the side face 130″ of the refractory brick 100″ at least two-thirds of the distance from the first face 110″ to the second face 120″. In certain non-limiting embodiments, the indicia 160′, 160″ is on the side face 130′, 130″ at least half the distance from the first face 110′, 110″ to the second face 120′, 120″. Placement of the indicia 160′, 160″ on the side face 130′, 130″ at a distance from the first face 110′, 110″ may reduce the risk that the indicia will be lost or obscured as the brick 100′, 100″ wears away or is otherwise affected in service in a lining over time by the environment within a high-temperature vessel.

In the non-limiting embodiment illustrated in FIG. 3, the side face 130′ defines a centerline C substantially perpendicular to both the first face 110′ and the second face 120′, and the indicia 160′ is on the side face 130′ downward from the centerline C, i.e., toward the bottom of FIG. 3. Similarly, in the non-limiting embodiment illustrated in FIG. 4, the side face 130″ defines a centerline C′ substantially perpendicular to both the first face 110″ and the second face 120″, and the indicia 160″ are on the side face 130″ upward and downward from the centerline C′. As used herein, the terms “top,” “bottom,” “front,” “rear,” “side,” “upward,” “downward,” and other directional terms are not intended to require any particular orientation, but are instead used for purposes of description only. In certain non-limiting embodiments, the centerline C, C′ is substantially perpendicular to at least one of the first face and the second face, and the indicia is on the side face to one side of the centerline C, C′. Placement of the indicia 160′, 160″ on the side face 130′, 130″ on one side of the centerline C, C′ may facilitate precisely identifying the position of the refractory brick in a particular high-temperature vessel after the refractory brick is removed from the high-temperature vessel.

In the non-limiting embodiment illustrated in FIG. 3, the indicia 160′ is on the concave, female portion 150′ of the brick 100′. In other non-limiting embodiments, the indicia 160′ can be on the convex, male portion 140′ of a refractory brick having a male and a female side face. In still other non-limiting embodiments, the indicia 160′ can be on both the male portion 140′ and the female portion 150′. More generally, although FIGS. 2 and 3 illustrate embodiments of a refractory brick according to the present disclosure including only a single indicia, multiple indicia may be present as illustrated in FIG. 4, and on more than one of the second face and the side face.

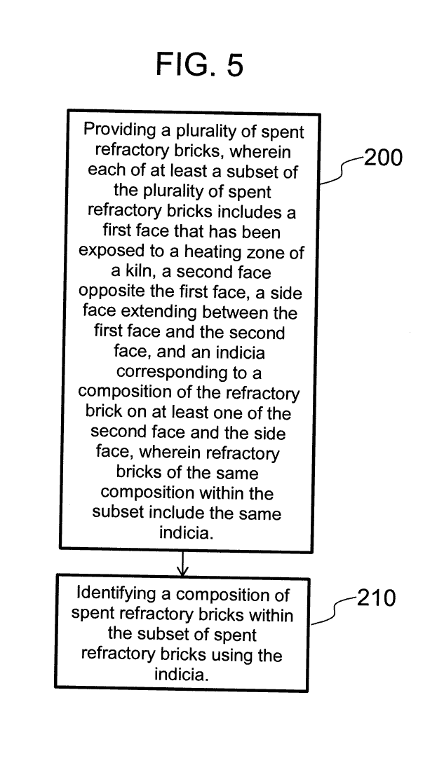

Referring to FIG. 5, a non-limiting embodiment of a method of identifying a composition of at least a subset of a plurality of spent refractory bricks according to the present disclosure is illustrated. A plurality of spent refractory bricks is provided (block 200). The plurality of spent refractory brick may be obtained, for example, by tearing out a refractory brick lining of a high-temperature vessel after a period of operation. Alternatively, the plurality of spent bricks may be obtained from one or more refractory linings removed from a high-temperature vessel and/or from some other source. It will be understood that the actual source of the refractory bricks is unimportant, but rather that the plurality of bricks have been used in a lining of a high-temperature vessel that has been in operation for a period of time. Each of at least a subset of the plurality of spent refractory bricks includes a first face that has been exposed to a heating zone of a high-temperature vessel, a second opposite the first face, a side face extending between the first face and the second face, and an indicia on at least one of the second face and the side face corresponding to a composition of the refractory brick. Refractory bricks of the same composition within the subset include the same indicia. A composition of the spent refractory bricks within the subset of spent refractory bricks is identified using the indicia (block 210). Bricks identified as having a composition that can be re-used as recycle material can be suitably processed and used in place of virgin raw materials in the production of new refractory bricks. Any bricks including indicia corresponding to a composition that should be avoided as recycle material can be identified. Any bricks lacking indicia can be analyzed by conventional means to determine composition and corresponding suitability for use a recycle material in production of new refractory brick.

Although the foregoing description has necessarily presented only a limited number of embodiments, those of ordinary skill in the relevant art will appreciate that various changes in the articles, methods, and other details of the examples that have been described and illustrated herein may be made by those skilled in the art, and all such modifications will remain within the principle and scope of the present disclosure as expressed herein and in the appended claims. It is understood, therefore, that the present invention is not limited to the particular embodiments disclosed or incorporated herein, but is intended to cover modifications that are within the principle and scope of the invention, as defined by the claims. It will also be appreciated by those skilled in the art that changes could be made to the embodiments above without departing from the broad inventive concept thereof.

We claim:

1. A refractory brick comprising:
a first face configured to be disposed toward a heating zone of a high-temperature vessel;
a second face opposite the first face;
a side face extending between the first face and the second face; and
an indicia on at least one of the second face and the side face, the indicia corresponding to a composition of the refractory brick.

2. The refractory brick of claim 1, wherein the indicia comprises an indentation.

3. The refractory brick of claim 1, wherein the indicia comprises at least one of a notch, a groove, and a dimple.

4. The refractory brick of claim 1, wherein the indicia comprises a color.

5. The refractory brick of claim 1, wherein the indicia comprises at least one of a number, a letter, and a symbol.

6. The refractory brick of claim 1, wherein the indicia is on the second face.

7. The refractory brick of claim 1, wherein the indicia is on the side face at least half the distance from the first face to the second face.

8. The refractory brick of claim 1, wherein the indicia is on the side face at least two-thirds of the distance from the first face to the second face.

9. The refractory brick of claim 1, wherein the side face defines a centerline substantially perpendicular to at least one of the first face and the second face, and the indicia is on the side face to one side of the centerline.

10. The refractory brick of claim 1, wherein the side face comprises a male portion and a female portion, and the indicia is on at least one of the male portion and the female portion.

11. A set of refractory bricks comprising:
a first refractory brick including a first face configured to be disposed toward a heating zone of a high-temperature vessel, a second face opposite the first face, and a side face extending between the first face and the second face of the first refractory brick; and
a second refractory brick including a primary face configured to be disposed toward the heating zone of the high-temperature vessel, a secondary face opposite the primary face, a second side face extending between the primary face and the secondary face, and an indicia on at least one of the secondary face and the second side face, wherein the indicia corresponds to a composition of the second refractory brick.

12. The set of refractory bricks of claim 11, wherein the first refractory brick comprises a first material, the second refractory brick comprises a second material, and the first material and the second material differ and are selected from alumina-magnesia-carbon, magnesia-carbon, alumina-carbon, magnesia-alumina-carbon, and alumina-carbon-silicon carbide.

13. The set of refractory bricks of claim 11, wherein the indicia comprises an indentation.

14. The set of refractory bricks of claim 11, wherein the indicia comprises at least one of a notch, a groove, and a dimple.

15. The set of refractory bricks of claim 11, wherein the indicia comprises a color.

16. The set of refractory bricks of claim 11, wherein the indicia comprises at least one of a number, a letter, and a symbol.

17. The set of refractory bricks of claim 11, wherein the indicia is on the secondary face.

18. The set of refractory bricks of claim 11, wherein the indicia is on the second side face at least half the distance from the primary face to the secondary face.

19. The set of refractory bricks of claim 11, wherein the indicia is on the second side face at least two-thirds of the distance from the primary face to the secondary face.

20. The set of refractory bricks of claim 11, wherein the second side face defines a centerline substantially perpendicular to at least one of the primary face and the secondary face, and the indicia is on the second side face to one side of the centerline.

21. The set of refractory bricks of claim 11, wherein the second side face comprises a male portion and a female portion, and the indicia is on at least one of the male portion and the female portion.

22. A method of identifying a composition of at least a subset of a plurality of spent refractory bricks, the method comprising:
providing a plurality of spent refractory bricks, wherein each of at least a subset of the plurality of spent refractory bricks includes
a first face that has been exposed to a heating zone of a high-temperature vessel,
a second face opposite the first face,
a side face extending between the first face and the second face, and
an indicia corresponding to a composition of the refractory brick on at least one of the second face and the side face, wherein refractory bricks of the same composition within the subset include the same indicia; and
identifying a composition of the spent refractory bricks within the subset of spent refractory bricks using the indicia.

23. The method of claim 22, wherein the indicia comprises an indentation.

24. The method of claim 22, wherein the indicia comprises at least one of a notch, a groove, and a dimple.

25. The method of claim 22, wherein the indicia comprises a color.

26. The method of claim 22, wherein the indicia comprises at least one of a number, a letter, and a symbol.

27. The method of claim 22, wherein the indicia is on the second face.

28. The method of claim 22, wherein the indicia is on the side face at least half the distance from the first face to the second face.

29. The method of claim 22, wherein the indicia is on the side face at least two-thirds of the distance from the first face to the second face.

30. The method of claim 22, wherein the side face defines a centerline substantially perpendicular to at least one of the first face and the second face, and the indicia is on the side face to one side of the centerline.

31. The method of claim 22, wherein the side face comprises a male portion and a female portion, and the indicia is on at least one of the male portion and the female portion.
